(19) United States
(12) Patent Application Publication
(10) Pub. No.: US 2001/0045325 A1
(43) Pub. Date: Nov. 29, 2001

(54) Elastic motor

(76) Inventor: Lewis Illingworth, Kensington, NH (US)

Correspondence Address: Ward & Olivo, Suite 300, 382 Springfield Avenue, Summit, NJ, 07901, US

(21) Appl. No.: 09/802,265

(22) Filed: Mar. 8, 2001

Related U.S. Application Data
(63) Continuation-in-part of application No. 09/578,419, filed on May 25, 2000.

(51) Int. Cl. F03G 1/00

(52) U.S. Cl. 185/39; 185/37

(57) ABSTRACT

An improved elastic motor is disclosed having a constant torque characteristic. The motor utilizes a reel with elastic stretched to its maximum tension. Each unit length of the elastic is allowed to relax back to its normal state while generating work in a process that will continue until the wheel is fully unwound. The present invention will ease design of mobile devices and the like by providing a power source having a predictable and stable output characteristic.

### CROSS REFERENCE TO OTHER APPLICATIONS

This application is filed as a continuation-in-part of co-pending Application Ser. No. 09/578,419 entitled “Elastic Motor” filed May 25, 2000.

### FIELD OF THE INVENTION

This invention relates generally to elastic motors, and more specifically, to an improved elastic motor having constant torque characteristics.

### BACKGROUND OF THE INVENTION

Elastic motors have been employed for centuries and have found particular application in model airplanes for over 150 years. Typical prior art elastic motors, such as those used in a model airplane, generally comprise a rubber loop threaded through a hook on a propeller shaft and is further attached to another hook at the tail of the craft. As the motor is wound up it first twists the elastic into a skein, then a row of knots form and spread along the whole length. A third stage occurs when a row of knots forms in the already knotted skein. When this row is complete the rubber is substantially stretched to its limit.

Upon release of propeller, there is a burst of power. When this is spent, a period of slowly declining torque follows for the majority of the motor run and is followed by a decline to zero torque.

The torque characteristics of the prior art elastic motor devices, like those described above, make model airplane design a considerable challenge. Clearly, this is because it is difficult for a designer to properly construct design constraints when the source of propulsion has such wavering torque characteristics. Aside from model airplane design, conventional elastic motors have undesirable performance in other applications as well. The knotting of the rubber introduces internal friction in the wound skein that can be eased somewhat by lubrication. Lubrication, however, drastically reduces the useful life of the rubber.

Therefore, the shortcomings of the prior art suggest a strong need for an elastic motor design that has a constant torque characteristic and does not damage the elastic material.

One particular U.S. Patent which aims to answer this need for a constant torque producing elastic motor is McAneny U.S. Pat. No. 4,629,438 which discloses a rubber band powered motor for a model airplane. McAneny teaches of a method of providing an extended flight through means of producing a more stable torque to improve upon designs comprising a wind up rubber band with a sudden burst output. Thus, the elastomeric members are either fully stretched, fully relaxed, in brief stretching mode or in brief relaxing mode. As a result, McAneny relies on tapes and gears, coupled to the multiple number of elastomeric members, to absorb the sudden bursts and function to produce a more stable torque output. However, McAneny teaches of an approximately steady torque output which extends the period of decay but does not provide for a periodic torque output which can be approximated as constant under certain heavy loads. Additionally, McAneny relies upon components, namely gears and tapes, which may add significant weight, cost and size to the design, all of which are undesirable characteristics for most applications.

Thus, there exists a need for an elastic motor which can provide an approximately constant torque output while still retaining desirable and practical characteristics such as light weight, low cost and small size.

### SUMMARY OF THE INVENTION

The present invention is directed towards an elastic motor, more specifically, to an elastic motor having a constant torque characteristic.

The motor system of an embodiment of the present invention starts with a reel which is wound with elastic stretched to its maximum tension. Each unit length of the elastic is allowed to relax back to its normal state while generating torque in a process that continues until the reel is fully unwound. The process may be seen as analogous to a steam engine which has a supply of steam at constant pressure. Portions of steam are fed to a cylinder where they expand to generate work (pressure times change in volume) by pushing a cylinder back to turn a wheel. When the expansion is complete the steam is exhausted and the process repeated. In the case of the present invention, a unit length of stretched elastic is connected into a system and allowed to contract to its unstressed state while turning a wheel and developing work. When fully contracted the relaxed elastic is fed to a take up reel and a new unit length of stretched elastic is taken. The process is continued until all the stretched elastic is used up. There is no twisting or knotting of the elastic and no need to lubricate it to prevent binding and wear as in a twisted skein, although some lubrication may assist operation.

Additionally, similar results can be obtained through the use of more than one spool, wherein each spool has a corresponding elastic member of which its transition from a tense state to a relaxed state represents one torque period, and all torque periods collectively yielding an approximate torque output. In such an embodiment, sensing means may allow for the spools to release the tension of their corresponding elastic members in series whereupon each new torque period begins when the previous spool reaches a certain level of low tension.

Furthermore, certain applications may be enhanced through the use of an elastic motor of the present invention with a minimum number of moving parts. Such a design may comprise the continuous transfer of an elastic member between two spools. This concept may be realized through the inclusion of a flat drive spool whereupon an elastic member is stretched and releases tension upon each rotation in a periodic fashion. Pinch rollers may be included to yield a desired tension in the elastic member as the portions of the elastic member that have released tension are left slack beyond the pinch rollers. Optionally, a take up spool may be included in addition to, or in place of, pinch rollers.

Hence, it is an object of the invention to provide an improved elastic motor.

Furthermore, it is an object of the invention to provide an improved elastic motor having a constant torque characteristic.

Further, it is an object of the invention to provide an improved means of powering portable devices.

Additionally, it is an object of the invention to provide an elastic motor having increased elastic material life.

Further, it is an object of the invention to provide an improved means of driving a dynamo.

Furthermore, it is an object of the invention to provide an improved means of powering wind-up toys and devices.

These and other objects will become apparent to those skilled in the art upon study of the following drawings and detailed description.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 (FIG. 1) depicts an elastic motor typical of the prior art.

FIG. 2 (FIG. 2) depicts the torque characteristics of an elastic motor typical of the prior art.

FIG. 3A (FIG. 3A) depicts an elastic motor, in accordance with the present invention, in wind up mode.

FIG. 3B (FIG. 3B) depicts an elastic motor, in accordance with the present invention, in the start of operating mode.

FIG. 3C (FIG. 3C) depicts an elastic motor, in accordance with the present invention, at the end of the first cycle of operation.

FIG. 3D (FIG. 3D) depicts the behavior of the elastic material in an elastic motor in accordance with the present invention.

FIG. 3E (FIG. 3E) depicts the torque characteristics of an elastic motor in accordance with the present invention.

FIG. 4A (FIG. 4A) depicts an alternate embodiment of an elastic motor in accordance with the present invention.

FIG. 4B (FIG. 4B) depicts an alternate embodiment of an elastic motor in accordance with the present invention, in operational mode.

FIG. 5A (FIG. 5A) depicts an alternate embodiment of an elastic motor in accordance with the present invention utilizing crossbars in the elastic.

FIG. 5B (FIG. 5B) depicts a detail of the elastic used in the device of FIG. 5A.

FIG. 6 (FIG. 6) depicts an embodiment of a multiple spool elastic motor in accordance with the present invention.

FIG. 7 (FIG. 7) depicts a detail of the transition between a leading and following reel in an embodiment of a multiple spool elastic motor in accordance with the present invention.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

Certain terminology will be used in the following description for convenience in reference only and will not be limiting. The words “in” and “out” will refer to directions toward and away from, respectively, the geometric center of the device and designated and/or reference parts thereof. The words “up” and “down” will indicate directions relative to the horizontal and as depicted in the various figures. The words “clockwise” and “counterclockwise” will indicate rotation relative to a standard “right-handed” coordinate system. Such terminology will include the words above specifically mentioned, derivatives thereof and words of similar import.

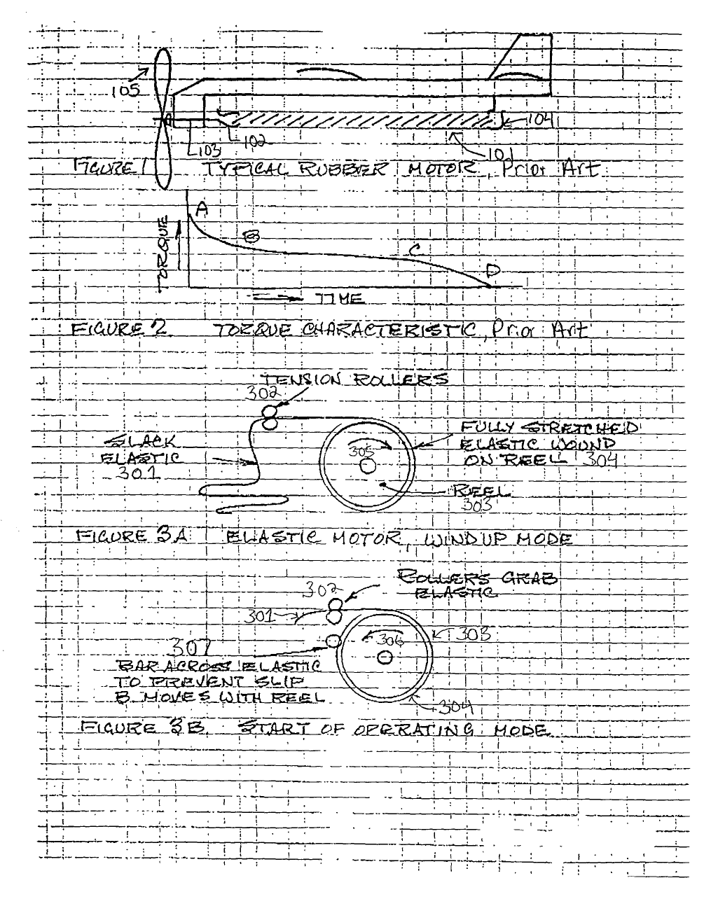

Referring first to FIG. 1, depicted is a typical prior art elastic motor in a model airplane. A rubber loop 101 is threaded through a hook 102 on the propeller shaft 103 and is attached to another hook 104 at the tail. As the motor is wound up it first twists into a skein, then a row of knots form and spread along the whole length. A third stage occurs when a row of knots forms in the already knotted skein. When this row is complete the rubber is generally stretched to its limit.

Upon release of propeller 105 there is a burst of power, A to B as depicted on the torque characteristic of FIG. 2. When this is spent, a period of slowly declining torque B to C follows for the majority of the motor run and is followed by a decline to zero torque, points C to D.

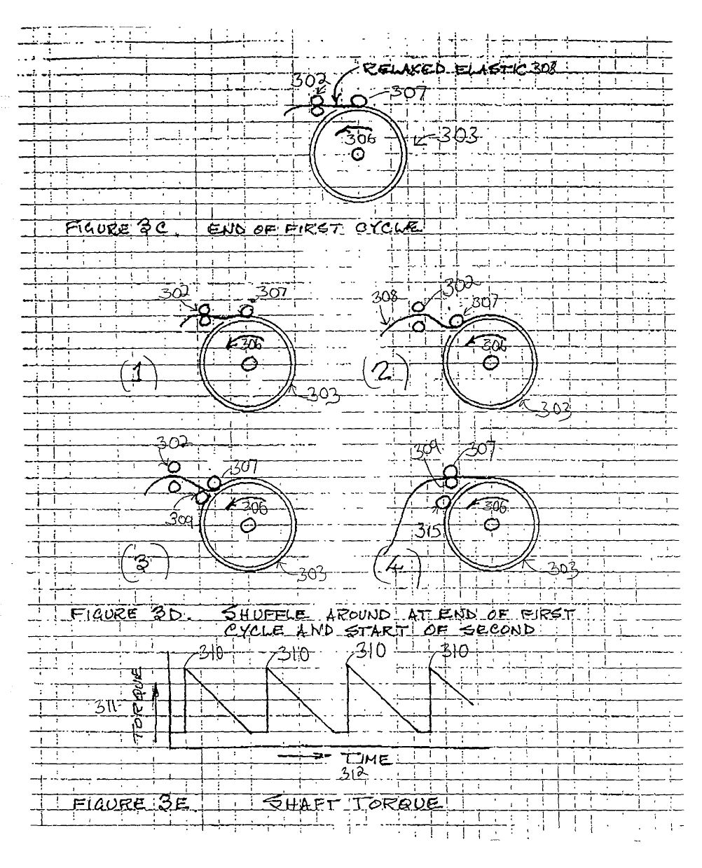

FIG. 3A through 3D show a first embodiment of the present invention. FIG. 3A shows an elastic motor in accordance with the present invention in wind up mode. Fully relaxed elastic 301 passes through movable rollers 302 as reel 303 rotates in a clockwise direction 305. The elastic 304 is wound at constant tension and is fully stretched.

In FIG. 3B, an elastic motor in accordance with the present invention at the start of operating mode is depicted. Movable rollers 302 grab the elastic 301 close to the reel 303. Bar 307 is coupled to the reel 303 and is used to prevent slip of the stretched elastic 304. The length of the elastic between 307 and 302 is NL where L is a unit length of relaxed elastic. The operation cycle allows this to be relaxed back to its relaxed length L while the tension in the elastic provides torque to turn reel 303 and supply power to a load. Reel 303, upon release, will begin to rotate in a counterclockwise direction 306.

FIG. 3C depicts an elastic motor in accordance with the present invention at the end of the first operating cycle. Reel 303 is allowed to release, causing counterclockwise rotation 306. The length between rollers 302 and bar 307 shortens to unit length L as the tension in the elastic 308 decreases until complete relaxation.

FIG. 3D depicts an elastic motor in accordance with the present invention that is capable of multiple operating cycles. This is accomplished by introducing an additional bar 309 and disengaging bar 307. In FIG. 3D(1), the elastic motor is shown at the end of the first operating cycle, as described above in FIG. 3C. In FIG. 3D(2), rollers 302 are first backed up and the elastic 308 is released. Bar 307 remains engaged to maintain secure contact between elastic 308 and reel 303. Reel 303 continues to rotate in counterclockwise direction 306. In FIG. 3D(3) the changeover point between cycles is shown. While the elastic remains released between reels 302, additional bar 309 is introduced between bar 307 and elastic 308. Reel 303 is poised to continue rotation in counterclockwise direction 306. In FIG. 3D(4) the start of the second cycle is shown. Pinch rollers 307 and 309 are moved to position 302 and new clamping bar 315 is placed in the initial position of 307 as in FIG. 3B. Clamping rollers 307 and 309 are opened and elastic 308 is released. This cycle is identical to the start of the first operating cycle described in FIG. 3B, with bar 307 replaced with bar 315. Reel 303 is now ready to continue rotating in counterclockwise direction 306 until bar 315 approaches clamping rollers 307 and 309 in position 302. At that point, the cycle repeats with bar 315 in position of 307 of FIG. 3D(1). The pinch rollers 302 and clamping bars 307, 315 and 309 recycle their functions with each ensuing cycle.

FIG. 3E depicts the output torque characteristics of the elastic motor just described. Torque is plotted on axis 311 versus time on axis 312. Peak values 310 are equal to the elastic tension multiplied by the reel radius. The average output torque is half that amount and is constant throughout operation.

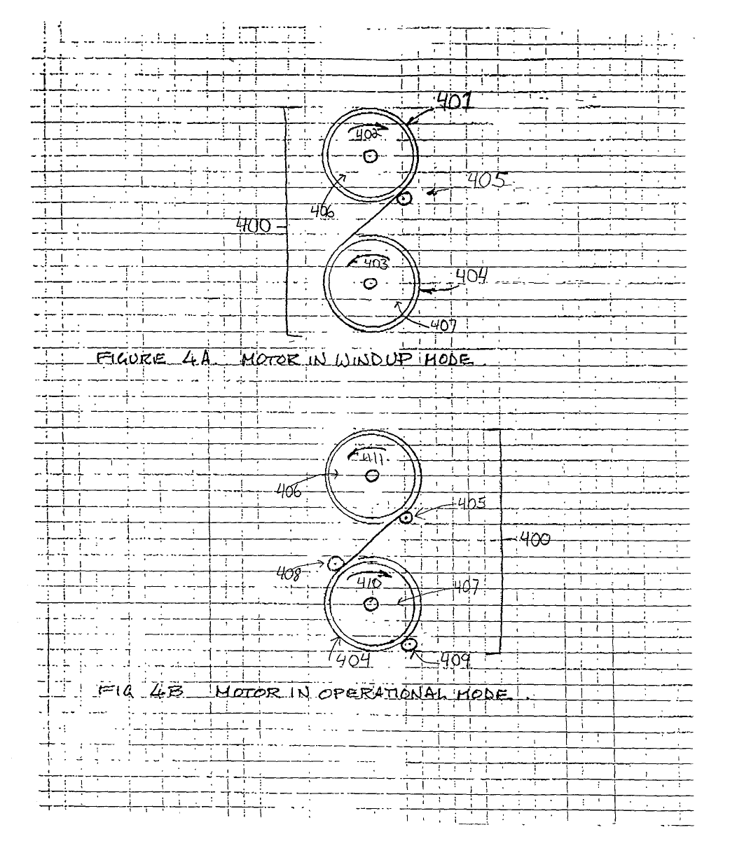

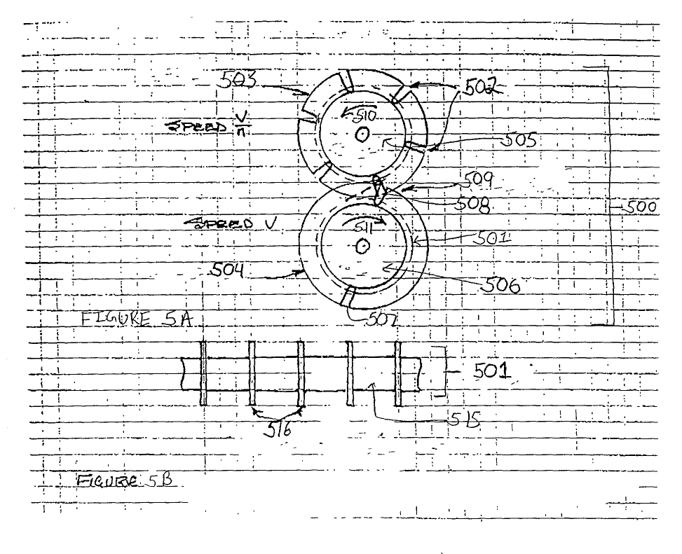

Another embodiment of the present invention comprises two reels, one for relaxed elastic, the other for stretched elastic. The two reels may be the same size, but it is not necessary. Differing diameters or geometries can provide different output characteristics. FIG. 4A depicts an exemplary motor 400 in accordance with this embodiment of the present invention. Motor 400 is shown in wind up mode. Reel 406 is loaded with relaxed rubber 401, the end of which is connected to opposing reel 407. Reel 406 rotates in a clockwise direction 403 and reel 407 rotates in counterclockwise direction 403. The elastic 404 wound on reel 407 is stretched to n times its lengthened, and optimally, is at full tension. Thus reel 407 turns n times as fast as reel 406. Roller 405 prevents the elastic 401 on reel 406 from slipping over itself and ruining the tension relationship.

FIG. 4B depicts the motor 400 in operational mode, wherein the device is producing work. Reel 407 has two bars 408 and 409 pressing against the elastic 404 to prevent slippage. Reel 407 rotates in clockwise direction 410 taking bars 408 and 409 with it. Opposing reel 406 rotates in counterclockwise direction 411. When bar 408 approaches roller 405, the elastic 404 between bar 408 and roller 405 is in its relaxed state. At this point, roller 405 is disengaged to allow bar 408 to pass and further allow elastic 404 to wind onto reel 406. After bar 408 passes, roller 405 is put back in place. Bar 408 is now removed and the elastic 404 between bar 407 and roller 405 undergoes the same process. At this point, bar 408 is replaced and is ready for the next cycle. Motor 400 is capable of multiple operating cycles.

Such a device 400 as described can achieve the required operation, however, the need to remove and replace bars 408 and 409 and roller 405 complicates operation. Thus, an alternate embodiment is depicted in FIG. 5A. An elastic sheet 501 is used comprising integral crossbars that engage in slots 502, 507 and 508 on reel end plates 503 and 504 to maintain the high and low tension zones in the elastic 501 and allow automatic transfer between the two reels 505 and 506 without the need for any other moving parts. The two reels 505 and 506 are fitted with slotted end plates 503 and 504. Reel 505 rotates in counterclockwise direction 510 n times as fast as reel 506 rotates in clockwise direction 511. Reel 506 has two slots 507 and 508 in its end plates. Reel 505 has 2n slots 502 in its end plates 503. The end plates 503 and 504 overlap at point 509 so that the elastic 501 can transfer between the reels 505 and 506 without any slipping and thus maintain the tension relationship. Rotating reel 506 counterclockwise will automatically stretch the elastic 501 to n times its original length. The two reels 505 and 506 could be coupled together by a gear box or a cog belt to have an n to 1 speed ratio and assist in maintaining accurate alignment. Coupling the two reels 505 and 506 together reduces the output torque to [1−(1/n)] of the maximum. Thus, the higher the value of n, the higher the system efficiency.

FIG. 5B depicts a detail of the elastic used in device 500. Elastic 501 comprises an elastic strip 515 and integral crossbars 516. Crossbars 516 articulate with slots 502, 507 and 508 to constrain the movement of reels 505 and 506 and thus maintain the tension relationship.

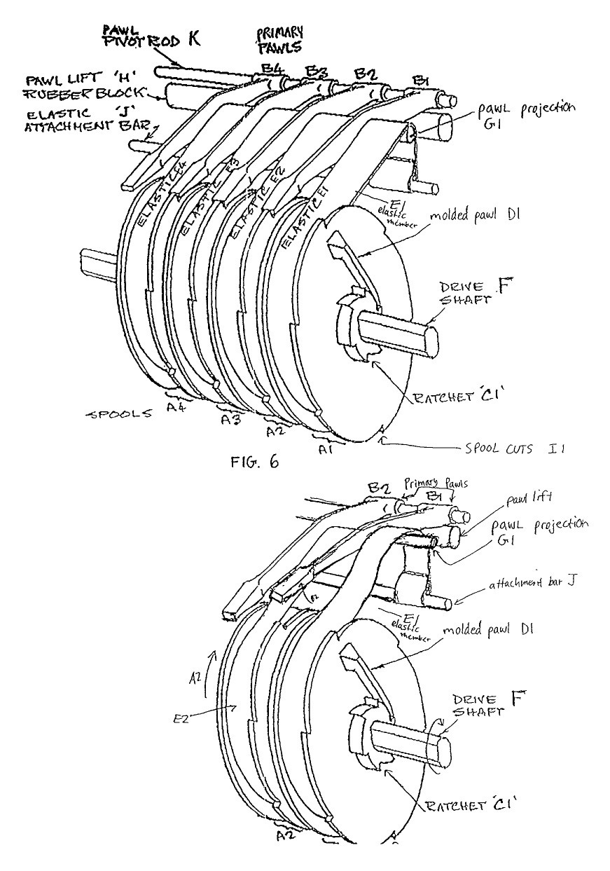

FIG. 6 depicts a multiple spool elastic motor with four spools A1-A4, although any number of spools may be used with this design for changing the duration of operation and without parting from the spirit and scope of the present invention. These spools A1-A4 rotate freely on drive shaft F. Said spools A1-A4 have corresponding elastic members E1-E4. Primary pawls Bl-B3 correspond to adjacent spools A2-A4. Primary pawl B4 is drawn only for consistency and is only used if a fifth spool is added to the present embodiment. Primary pawls B1-B3 function to prevent clockwise movement of spools A2-A4 upon tension of elastic members E2-E4. One end of each of elastic member E1-E4 is attached to a corresponding spool A1-A4, while the other end is wrapped around a pawl projection G1-G4 and secured around fixed elastic attachment bar J. This configuration results in an increasing downward force on primary pawls B1-B4 proportional to an increased tension in elastic members E1-E4. Pawl lift H produces a constant upward force upon said primary pawls B1-B4, which rotate independently on pivot rod K. When the tension in elastic members E1-E3 increases, primary pawls B1-B3 lower and engage spool cuts I2-I4, thus, resisting clockwise movement of spools A2-A4. An increase in tension of elastic member E4 would result in the lowering of primary pawl B4 to engage a spool cut I5 (not shown) if a fifth spool is added to the present embodiment. Molded pawls D1-D4 are joined to the outer side of spools A1-A4 on the section comprising spool cuts I1-I4. It should be noted that molded pawls D2-D4 are not shown due to their being hidden between said spools A1-A4. Ratchets C1-C4, placed on the outside of spools A1-A4, connect with molded pawls D1-D4 to provide high resistance for clockwise movement and negligible resistance for counter-clockwise movement of said spools A1-A4. It should also be noted that ratchets C2-C4 are not shown due to their being hidden between spools A1-A4. Coupling one of spools A1-A4 with its respective ratchet C1-C4 yields the coupling of said one of said spools A1-A4 to drive shaft F.

During initial stages, spools A1-A4 are wound counterclockwise simultaneously and tension in elastic members E1-E4 increases. This motion is transmitted to said spools A1-A4 by ratchets C1-C4 and molded pawls D1-D4 which spring into engagement. As elastic members E1-E4 stretch on spools A1-A4 they will slip over themselves and it is contemplated that a lubricant could be used to reduce friction. Primary pawls B1-B3 are pulled downwards by tension in elastic members E1-E3 to engage spool cuts C2-C4 and impede clockwise movement of spools A2-A4. Additionally, spool A1 is free to rotate clockwise in the present design, but may be prevented to do so by inserting a pin into ratchet C1.

Upon removal of said pin, spool A1 begins to turn clockwise and molded pawl D1 and ratchet C1 function to turn drive shaft F clockwise. A clockwise torque is produced at drive shaft F by said spool A1. As spool A1 turns clockwise, tension in elastic member E1 decreases and at some level of decreased tension the upward force from pawl lift H exceeds the downward force from tension in elastic member E1. At this point, primary pawl B1 raises above spool cut I2 on spool A2 and as a result, said spool A2 begins to provide a clockwise torque to drive shaft F. Upon the activation of said spool A2, elastic member E1 has been completely relaxed and spool A1 is no longer providing torque to drive shaft F.

The process described continues until all elastic members E1-E4 become fully relaxed. With each spool being turned, a naturally decaying torque cycle is produced at drive shaft F. Over the course of the entire operation, however, a periodic torque is produced wherein the relaxation of each spool A1-A4 represents one torque period, or cycle. Therefore, said periodic torque output at drive shaft F can be approximated as a constant torque.

FIG. 7 depicts a detail of the transition between a leading and following reel in an embodiment of a multiple spool elastic motor in accordance with the present invention. In this figure, elastic member E1 on spool A1 has released its tension and no longer provides torque to drive shaft F. Primary pawl B1, thus, raises as the upward force placed upon said primary pawl B1 by pawl lift H exceeds the downward force placed upon pawl projection G1 by said elastic member E1. As primary pawl B1 raises, said primary pawl B1 disengages spool cut I2 and spool A2 begins to rotate clockwise as tension in elastic member A2 begins to be released. As spool A2 rotates clockwise, molded pawl D2 springs into action with ratchet C2. Said ratchet C2 is further coupled with said spool A2 to provide a clockwise torque to drive shaft F.

The multiple spool elastic motor embodiment detailed in FIGS. 6 and 7 may operate as a single unit or may comprise additional elements. For example, other types of elastic motors may be coupled in a manner similar to that of the multiple spool elastic motor of FIGS. 6 and 7, or other types of elastic motors may function as individual elements along drive shaft F of FIGS. 6 and 7. One such element may be a pin rubber elastic motor design as in FIGS. 5A and 5B, wherein a plurality of spools are coupled to one another in a manner such as that of the multiple spool elastic motor of FIGS. 6 and 7 to provide operation for longer periods of time. An embodiment such as this, may comprise crossbars on an elastic sheet, such as the embodiment described in FIGS. 5A and 5B, or may comprise a variety of other plurality of continuous engaging and disengaging elements. Embodiments such as those which would comprise a plurality of the disclosed elements may provide such a multiplexing of elastic motors that large motors may be assembled which can operate for long periods of time.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

I claim:

1. A mechanical stored energy device comprising:
a first reel, said first reel being rotatable, and further comprising a lock to prevent rotation of said first reel;
a first endplate, coupled to said first reel, having a diameter substantially larger than said first reel and further having a common axis of rotation with said first reel, said first endplate further comprising a plurality of slots;
a member, said member being both flexible and stretchable, said member further comprising transverse bars, said member capable of winding upon said first reel under tension, wherein said tension stretches said member;
a second reel, said second reel being rotatable, said second reel coupled to said first reel via said member;
a second endplate, coupled to said second reel, and further overlapping said first endplate, having a diameter substantially larger than said second reel and further having a common axis of rotation with said second reel, said second endplate further comprising a plurality of slots;
wherein said transverse bars of said member articulate with said slots of said first endplate and said second endplate, thus, when said lock is released the energy stored in said member under tension is released, allowing the transfer of energy between said first reel and said second reel, causing rotation of said second reel, said rotation having a constant torque characteristic.

2. A mechanical stored energy device in accordance with claim 1, further comprising a motor wherein said motor rotates said first reel, thereby bringing said member into tension.

3. A mechanical stored energy device in accordance with claim 1, wherein said member is comprised of elastomeric material.

4. A mechanical stored energy device in accordance with claim 1, wherein said first reel is cylindrically shaped.

5. A mechanical stored energy device comprising:
a plurality of rotatable reels, said rotatable reels further comprising braking means;
a plurality of members, said members being both flexible and stretchable, said members capable of winding upon and attaching to said rotatable reels under tension,
wherein said tension stretches members;
a drive shaft for providing a torque, whereupon said rotatable reels are mounted;
a plurality of coupling means, said coupling means function to rotationally couple one of said rotatable reels to said drive shaft; and
bar means, attached to each of said members to secure said members to said rotatable reels.

6. A mechanical stored energy device in accordance with claim 5, wherein said rotatable reels are cylindrically shaped.

7. A mechanical stored energy device in accordance with claim 5, wherein said rotatable reels are axially mounted to said drive shaft.

8. A mechanical stored energy device in accordance with claim 5, wherein said members are of an elastomeric material.

9. A mechanical stored energy device in accordance with claim 5, further comprising wind-up means wherein said rotatable reels are wound, whereupon tension in said members increases.

10. A mechanical stored energy device in accordance with claim 9, wherein said rotatable reels are wound up simultaneously.

11. A mechanical stored energy device in accordance with claim 5, wherein said coupling means comprises a pawl and ratchet system comprising a plurality of pawls and ratchets, wherein said pawl and ratchet system transfers a torque from said rotatable reels to said drive shaft.

12. A mechanical stored energy device in accordance with claim 11, wherein said one or more pawls and ratchets interconnect, said one or more pawls providing drive means to said one or more ratchets upon a rotation and providing non-resistance upon an opposite rotation.

13. A mechanical stored energy device in accordance with claim 11, wherein said one or more pawls are mounted to one or more of said rotatable reels and said one or more ratchets are placed alongside of said one or more said rotatable reels and mounted axially upon said drive shaft to provide said torque to said drive shaft.

14. A mechanical stored energy device in accordance with claim 5, further comprising pawls on said rotatable reels and means for engaging said rotatable reels at said pawls.

15. A mechanical stored energy device in accordance with claim 14, further comprising brake means, said break means comprising:
an engaging pawl, wherein said engaging pawl connects with adjacent said reel cuts to resist a clockwise rotation and allow a counterclockwise rotation, and
a pivot rod, said pivot rod providing rotational means for said engaging pawls.

16. A mechanical stored energy device in accordance with claim 14, further comprising series application means, wherein said rotatable reels release tension in series.

17. A mechanical stored energy device in accordance with claim 14, wherein said series application means comprise pawl projections attached to said engaging pawls, wherein said members wrap over neighboring of said pawl projections and create a downward force on said neighboring of said pawl projections upon an increase in tension of said members.

18. A mechanical stored energy device in accordance with claim 17, further comprising an engaging pawl lift, said engaging pawl lift delivering an upward force upon said engaging pawls.

19. A mechanical stored energy device in accordance with claim 5, wherein first of said rotatable reels in line comprises locking means.

20. A mechanical stored energy device in accordance with claim 19, wherein said locking means comprises a locking pin inserted into said ratchet of said first of said rotatable reels in line and said ratchet of second of said rotatable reels in line.

21. A method for a mechanical stored energy device wherein energy is stored in a plurality of tension members wrapped around corresponding rotatable reels and wherein energy is released in series to provide a periodic torque output that can be approximated as a constant torque.
